(19) United States
(12) Patent Application Publication
(10) Pub. No.: US 2003/0011601 A1
(43) Pub. Date: Jan. 16, 2003

(54) Graphics image creation apparatus, and method and program therefor

(75) Inventors: Takayuki Itoh, Yokohama-shi (JP); Jun Doi, Yokohama-shi (JP)

Correspondence Address: IBM CORPORATION, INTELLECTUAL PROPERTY LAW DEPT., P.O. BOX 218 - 39-254, YORKTOWN HEIGHTS, NY, 10598, US

(73) Assignee: International Business Machines Corporation

(21) Appl. No.: 10/157,329

(22) Filed: May 29, 2002

(30) Foreign Application Priority Data
Jun. 19, 2001 (JP) 185569

(51) Int. Cl. G06T 11/20

(52) U.S. Cl. 345/440

(57) ABSTRACT

A graphics image for hierarchical graph data is generated in order beginning with the topmost level. When a sub-graph for a specific level is generated, and then a sub-graph for a lower level for a specific node in this sub-graph is generated, the size of the node for which the lower sub-graph is generated is changed so that the lower sub-graph is included in this node. Further, nodes near the node for which the size has been changed are moved, so that these nodes do not interfere with the sub-graph for the lower level.

### DESCRIPTION

1. Technical Field

The present invention relates to a graphics display technique for visualizing graph data that is constituted by nodes and arcs connecting the nodes.

2. Description of the Related Art

Graph data used to represent the relationship between the elements of a complete configuration can be visualized by using nodes to represent the elements and arcs to connect the nodes. Graphics displays used to visualize graph data can vary, and can include displays for the linked structure of web pages, for networks, such as those for financial, communication, transportation or social organizations, for data graphs for chemical or biological properties, for graphs showing the correlation of text data and image data, and for graphs used to delineate the operation of systems constituted by combinations of several relevant modules (e.g., the processing performed by a parallel processor). As a result, a demand exists for a computer display technique for graphics data that is applicable to a very wide range of fields.

In those fields for which a graph data display technique is required, the volume of the data to be handled has been drastically increased, and there are examples wherein the graph data to be processed is used to represent several thousand to several tens of thousands of nodes. However, it is difficult to display so many nodes in a limited display space, and even when they can be displayed, the nodes and arcs on the display are so complicated that the relationships existing between them can not easily be perceived, rendering such a display unrealistic.

For the graphics display of a large amount of graph data, an effective means is a hierarchical technique whereby, based on the structural relationship of graph data, the nodes constituting a graph are formed into groups, and the conjoining of these groups is employed to form larger groups.

For the hierarchical construction of graph data, a process for

(1) assembling several of the nodes constituting a graph to form groups, and

(2) forming sub-graphs in groups is repeated to obtain several groups (and sub-graphs formed in the groups). At this time, each sub-graph is called a “lower sub-graph”, and a graph representing the connections within a group is called a “higher sub-graph”. A graph including at least three levels can also be formed by repeating the process by which several groups constituting higher sub-graphs are assembled to produce a single group. FIGS. 27A to 27C are illustrations provided for an example graphics image consisting of three levels of hierarchical graph data; a graph including 23 nodes is divided into eight groups, a to h (FIG. 27A), which are then assembled into three groups, A to C (FIGS. 27B and 27C).

In order to effectively visualize the hierarchical graph data, the following processes must be performed.

(1) A process for appropriately and automatically arranging nodes and arcs constituting each sub-graph in order to avoid an erroneous reading.

(2) A process, in accordance with user performed manipulations, for automatically and dynamically arranging nodes down to the lowest level and for displaying all details.

(3) A process for the easy visual identification of the depth of the level of each node.

(4) A process for interactively enlarging and displaying a portion that a user is interested in, while at the same time avoiding any interference by the enlarged portion with peripheral portions.

For processes (1) and (2), a method using a dynamic model is effective because a satisfactory solution can be obtained within a reasonable time of from several seconds to several tens of seconds. According to this method, an equation of motion is resolved by employing an intermolecular model for a node in a graph and a spring model for an arc in the graph, while an appropriate location for each node is obtained.

An example method for the employment of a dynamic model for hierarchical graph data to determine node arrangement is described in the following reference document 1. Reference document 1: Graph drawing, clustering, and visual abstraction, A. Quigley, et al., Graph Drawing 2000.

For implementing processes (3) and (4), there is a conventional method whereby, on the assumption that sub-graphs of a graph have already been expanded in the xy plane, a different z value is provided for each level for the three dimensional display of the graph. FIG. 28 is a diagram showing an example wherein the hierarchical structure of a graph is displayed stereoscopically. This conventional technique is described in the following reference document 2, for example.

Reference document 2: Multilevel Visualization of Clustered Graphs, P. Eades, et al., Graph Drawing 1996 (http://www.cs.newcastle.edu. au/Research/qwfeng/RESEARCH/Multilevel/Multilevel.html

In addition, there is a conventional technique whereby a technique for visualizing a tree structure representing a hierarchy is employed to visualize hierarchical graph data. This conventional technique is described in the following reference document 3.

Reference document 3: Web-based visualization of Large Hierarchical Graphs Using Invisible Links in a Hyperbolic Space, Hao M. C., Hsu M., Dayal U. and Krug A., HP Laboratories Palo Alto, HPL-2000-2.

This conventional technique, according to which the hierarchical structure of nodes is represented using a graph, is a display method that provides for branches to be extended radially from a root node.

FIG. 29 is a diagram showing an example wherein the hierarchical graph data in FIG. 27 is represented by using the conventional method discussed in reference document 3.

As is shown in FIG. 29, according to this method the positional relationship of the nodes at different levels is represented by using arcs, and connections between nodes at the same level is not shown. For example, while in FIG. 27 node a is connected to three nodes b, c and d at the same level, this connection is not shown in FIG. 29. It should be noted that in accordance with the conventional technique discussed in reference document 3 an interface is proposed whereby the connection of an arbitrarily selected node and a related lower node can be displayed.

### BRIEF DESCRIPTION OF THE DRAWINGS

FIG. 1 is a diagram showing the configuration of a computer system that implements a graphics display technique for graph data according to one embodiment of the present invention.

FIG. 2 is a diagram showing the configuration of a graphics image creation system that implements the graphics display of graph data in accordance with the embodiment of the invention.

FIG. 3 is a flowchart showing the general graphics creation processing performed by the graphics image creation system according to the embodiment.

FIGS. 4A to 4C are diagrams showing an example state in which a graphics image is generated by the processing in FIG. 3.

FIG. 5 is a diagram showing an example graphics image generated in accordance with this embodiment.

FIGS. 6A and 6B are diagrams for explaining the partial space expansion process for a grid-shaped graphics image.

FIGS. 7A and 7B are diagrams showing the state wherein a sub-graph for the lower level of a predetermined node is arranged in space that is obtained by the performance of the partial space explanation process for the predetermined node.

FIG. 8 is a diagram for explaining perspective projection.

FIGS. 9A to 9F are diagrams showing the process for generating a graphics image for hierarchical graph data having 35 nodes and a three-level structure.

FIG. 10 is a diagram showing an example graphics image for hierarchical graph data that describe page linking information for a predetermined web site.

FIG. 11 is a diagram showing an example wherein hierarchical graph data is displayed using perspective projection in accordance with the embodiment.

FIG. 12 is a diagram showing the state wherein the location of a viewpoint in FIG. 11 is changed.

FIG. 13 is a diagram showing the state wherein a sub-graph for a predetermined lower level in FIG. 11 is observed.

FIG. 14 is a diagram showing an example graphics image generated for hierarchical graph data.

FIG. 15 is a diagram showing the state wherein a lower sub-graph is displayed by performing the partial space expansion process for a predetermined node in FIG. 14.

FIG. 16 is a diagram showing a graphics image that is generated in accordance with the embodiment for hierarchical graph data that represent the connection of web pages.

FIG. 17 is a diagram showing the state wherein the partial space expansion process is performed for several nodes in FIG. 16 to deform the graph.

FIGS. 18A to 18C are diagrams showing a graphics image generated in accordance with the embodiment for hierarchical graph data that represent connections for web pages different from that in FIG. 16.

FIGS. 19A and 19B are diagrams showing the state wherein perspective projection is employed for the state in FIG. 18, so that the sub-graph for a lower level seems to be located at a distance.

FIGS. 20A and 20B are diagrams showing the state wherein perspective projection is employed for the state in FIG. 18 so that the sub-graph for a lower level seems to be in the front.

FIG. 21 is a diagram showing a graphics image, i.e., a sub-graph for a topmost level, that is generated based on hierarchical graph data corresponding to the web site of a predetermined company.

FIG. 22 is a diagram showing a graphics image, i.e., a sub-graph for a lower level of the node “product introduction”, which is generated based on hierarchical graph data corresponding to the web site of the predetermined company.

FIG. 23 is a diagram showing a graphics image, i.e., a sub-graph for a lower level of the node “company overview”, that is generated based on hierarchical graph data corresponding to the web site of the predetermined company.

FIG. 24 is a diagram showing the state wherein the graphics image in FIG. 23 is displayed using perspective projection, so that a sub-graph for a higher level is arranged in front and a sub-graph for a lower level is arranged to the rear.

FIG. 25 is a diagram showing the state wherein the partial space expansion process is performed for the graphics image in FIG. 23, while the node “printer” at the lower level of node “product introduction” is used as the center point.

FIG. 26 is a diagram showing a graphics image that is generated based on hierarchical graph data that represent the structure of the personnel organization in a predetermined company.

FIGS. 27A to 27C is a diagram showing an example graphics image for the hierarchical graph data for three levels.

FIG. 28 is a diagram showing an example wherein the three dimensional hierarchical structure of a graph is displayed.

FIG. 29 is a diagram showing an example wherein the hierarchical graph data in FIG. 27 is displayed using a conventional method, as described in reference document 3.

### DESCRIPTION OF THE SYMBOLS

10: Computer system

11: Processor (CPU)

12: Main memory

13: Display device

14: Storage device

21: Sub-graph generator

22: Sub-graph corrector

23: Graph operation acceptance unit

24: Display controller

### SUMMARY OF THE INVENTION

As is described above, according to the present invention, a graphics display for hierarchical graph data can be presented in a form that ensures both the hierarchical structure of graph data and the connections of desired nodes can be understood.

According to the present invention, since graphs are dynamically arranged in accordance with operations performed by users, graphics displays for hierarchical graph data can be flexibly presented in accordance with requests transmitted by users.

The following problems, however, are encountered when these conventional graphics display techniques are employed for hierarchical graph data.

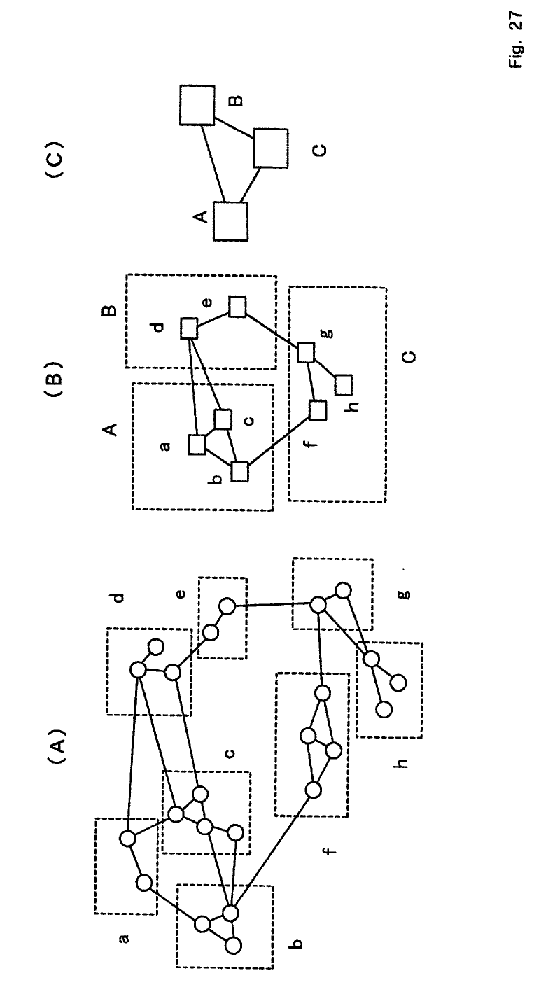

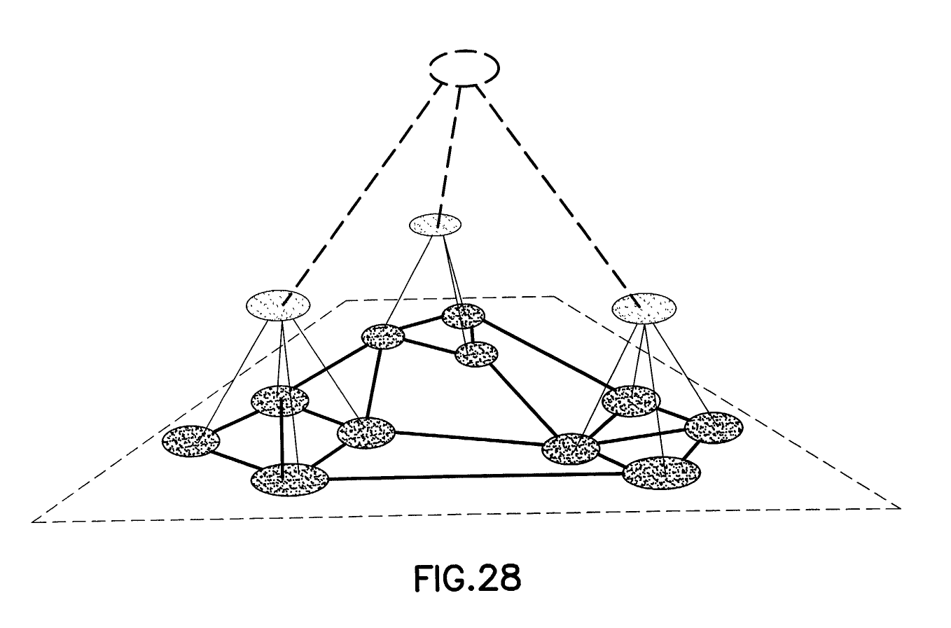

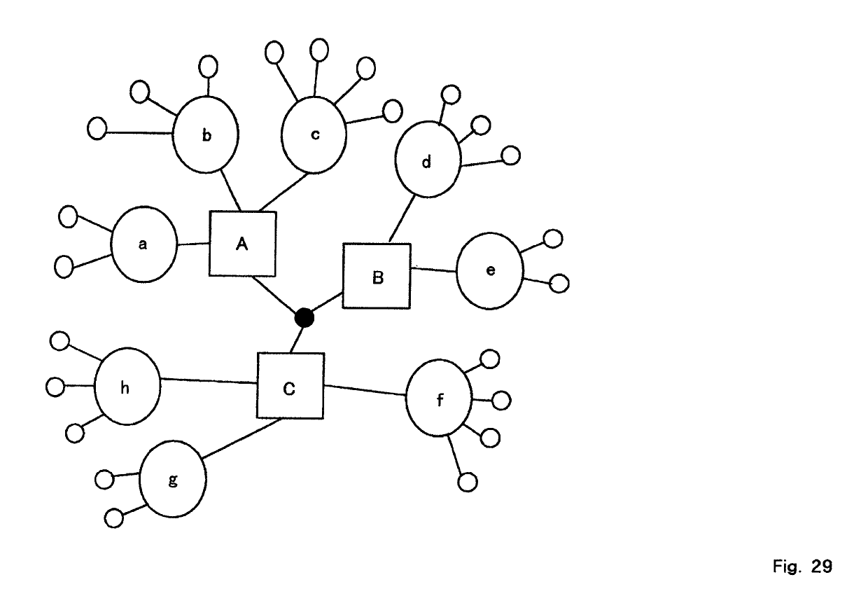

As is shown in FIG. 27, groups of nodes may be displayed at each level, ranging in order from a higher level to a portion (predetermined group) of a lower level (in this case, the lower level that is displayed is called a noted portion). In order to interactively implement the display process, a function is required whereby first only the sub-graph for a higher level is arranged automatically, and the sub-graph for a lower level is automatically arranged in the group of a noted portion in the sub-graph for the higher level.

However, in this case, since the area occupied by the lower level is unknown at the time whereat the higher level is automatically arranged, the nodes are automatically arranged beginning at the higher level while the area occupied by the node is constant. Therefore, when this method is employed for a hierarchical graph wherein, as a result of the automatic arrangement of nodes, an equal number of nodes is not present in the groups at the same level, i.e., wherein the sub-graphs for lower levels have a different node density (the number of nodes differs), or wherein the depths of the levels differ, interference between the nodes at the lower level or in the nodes between the lower level and the higher level may occur.

When nodes are to be displayed in the reverse order, i.e., from a lower level to a higher level, the arrangement can be controlled so as to avoid interference between nodes because the area occupied by each node constituting the higher level is already provided at the time the higher level was automatically arranged. However, since the node sizes increase consonant with the height of a level, a dynamic model used for automatic arrangement tends not to be stabilized and satisfactory arrangement effects are seldom obtained.

Furthermore, since the conventional graphics display technique for the hierarchical graph data requires an extended period of time for determination of the graph arrangement, generally, a graph arrangement is performed during the pre-process, and is displayed in accordance with user manipulation. Therefore, the user manipulation does not intermesh the graph arrangement, and it is not possible to present a flexible display for which a dynamically different graph is arranged in accordance with a user specified arrangement.

Generally, according to the conventional graphics display technique employed for graph data, parallel projection is employed for the three dimensional representation of a hierarchical graph. However, since during the visualization process, for which parallel projection is used, an object in the immediate foreground and an object at a distance are displayed using the same scale, practically, a user is unable to discern the depth of the level that is currently being accessed.

Further, since a large area is required to display the details of a noted portion, it is difficult to simultaneously display the details of a noted portion and an image of all the graph data using a screen that provides only limited display space.

The premise on which the conventional technique in reference document 3 is based is that the hierarchy of the nodes can be represented using arcs extending radially from a predetermined node. Further, according to this technique the connection of nodes at the same level can also be displayed. However, since a preference is given for the representation of the hierarchical levels, the resultant screen display is complicated, and the node connections can not easily be discerned.

It is, therefore, one object of the present invention to present for hierarchical graph data a graphics display having a form that ensures both the hierarchical structure of graph data and the connections between desired nodes are easily and simultaneously apprehended.

It is another object of the present invention to present for hierarchical graph data a flexible graphics display wherein graphs are dynamically arranged as desired in accordance with manipulations performed by a user.

### SUMMARY OF THE INVENTION

To achieve the above objects, according to a first aspect of the invention, a graphics image creation apparatus characterized by the following configuration can be provided. A graphics image creation apparatus comprises: a sub-graph generator, for employing hierarchical graph data to generate a sub-graph constituting a graphics image at a predetermined level; and a sub-graph corrector, for, when the sub-graph generator has generated a sub-graph for a level lower than a predetermined node in the sub-graph that has already been generated, correcting the location of a node in the sub-graph that has already been generated, so that interference is avoided between the sub-graph that has already been generated and the sub-graph for the lower level.

Specifically, the sub-graph corrector changes the size of a node that corresponds to the sub-graph that is newly generated for the lower level, so that the sub-graph for the lower level is included in the node for which the size had been changed, and removes all other nodes from the sub-graph that has already been generated.

Further, the sub-graph corrector rearranges nodes by locally employing a dynamic model between the node for which the size has been changed and another nearby node.

According to a second aspect of the present invention, a graphics image creator apparatus characterized by the following configuration is provided. A graphics image creation apparatus comprises: a processor, for generating a graphics image based on graph data; and a display unit, for displaying the graphics image generated by the processor, wherein, when the processor generates a sub-graph that constitutes a graphics image for a predetermined level in hierarchical graph data, the processor changes the size of a node that corresponds to the sub-graph so as to include the sub-graph in the node, and moves a neighboring node of the node for which the size has been changed in order to avoid any interference with the sub-graph.

To change a node size, the processor employs, as the size of a node that corresponds to the sub-graph, the area occupied by the sub-graph in the display space of the display unit. Further, when a sub-graph for a predetermined level is corrected, the processor changes the size of a node in accordance with the sub-graph that has been corrected, and moves a node near the node for which the size has been changed in order to avoid any interference with the sub-graph.

In addition, when a generated graphics image has a hierarchical structure, the display unit displays an arbitrary level using a perspective projection appropriate for a display screen.

According to a third aspect of the present invention, a graphics image creation apparatus characterized by the following configuration can be provided. A graphics image creation apparatus comprises: a processor, for generating a graphics image based on graph data; and a selected node receiver, for accepting a node that is selected to constitute a first graphics image that is generated by the processor, wherein, when graph data for a lower level exists for a node that is accepted by the selected node receiver, the processor generates a second graphics image based on the graph data for the lower level, and corrects the first graphics image so as to avoid any interference with the second graphics image.

According to a fourth aspect of the present invention, a graphics image creation apparatus comprises the processor and the selected node receiver described above, wherein, in a display space wherein a graphics image is displayed, the processor moves other displayed nodes away in directions opposite to those leading to a center point that corresponds to the coordinate values for a selected node that is accepted by the selected node receiver.

The processor determines a travel distance for the node based on the distance from the selected node, which is accepted by the selected node receiver, and the hierarchical structure of the generated graphics image.

According to a fifth aspect of the invention, a graphics image creation method for reading graph data from a storage device and transmitting the graph data to a data processor to generate a graphics image comprises the steps of: generating a graphics image based on graph data to be processed; and when the newly generated graphics image is a part of a graphics image that has already been generated and is correlated with a predetermined node in the graphics image that has already been generated, rearranging nodes of the graphics image that has already been generated.

The step of rearranging nodes includes the steps of: changing the size of a node that corresponds to the graphics image that is newly generated, so as to include in the node the graphics image that is newly generated; and moving another node in the graphics image that has already been generated so as to distance that node from the node for which the size has been changed.

According to a sixth aspect of the invention, a graphics image creation method comprises the steps of: generating a sub-graph that is a graphics image for a predetermined level of hierarchical graph data that is to be processed; generating a sub-graph for a level lower than a predetermined node in the sub-graph for the predetermined level; changing the size of a node for which the sub-graph for the lower level is generated, so that the node includes the sub-graph for the lower level; and moving another node near the node for which the size has been changed, so that interference with the sub-graph for the lower level is avoided.

According to a seventh aspect of the present invention, a graphics image creation method comprises the steps of: accepting an arbitrarily selected node constituting a graphics image displayed on a display device; generating a graphics image for a level lower than the selected node; changing the size of the selected node, so that the graphics image for the lower level is included; and moving another node near the node for which the size has been changed, so that interference with the graphics image for the lower level is avoided.

According to an eighth aspect of the present invention, a graphics image creation method comprises the steps of: accepting an arbitrarily selected node constituting a graphics image displayed on a display device; and moving other displayed nodes in directions leading away from a center point that is the coordinate values for the selected node.

Furthermore, the present invention can be provided as a program that permits a computer to perform the processes corresponding to the steps of the above described graphics image creation methods. This program can be provided by being stored on a storage medium, such as a magnetic disk, an optical disk or a semiconductor storage device, or by being distributed via a network by the storage device of a program transmission apparatus connected to the network.

### DETAILED DESCRIPTION OF THE INVENTION

The preferred embodiment of the present invention will now be described in detail while referring to the accompanying drawings.

In this embodiment, a computer system performs a graphics display process by which graph data, used to describe relationships among constituent elements of a configuration, are presented and visualized using nodes to represent individual elements and using arcs to connect the nodes.

In the following description, a graphics image for hierarchical graph data for a predetermined group at each level is called a sub-graph, regardless of its hierarchical location. This is because the hierarchical structure of the graph data can include an arbitrary number of levels, and because the level hierarchy is merely the correlation of the individual levels. Further, when a “group” is simply represented, it is not based on the hierarchical structure. And when the hierarchical location of a level must be identified, the expression a “sub-graph for a higher level” or a “group at a lower level” is employed.

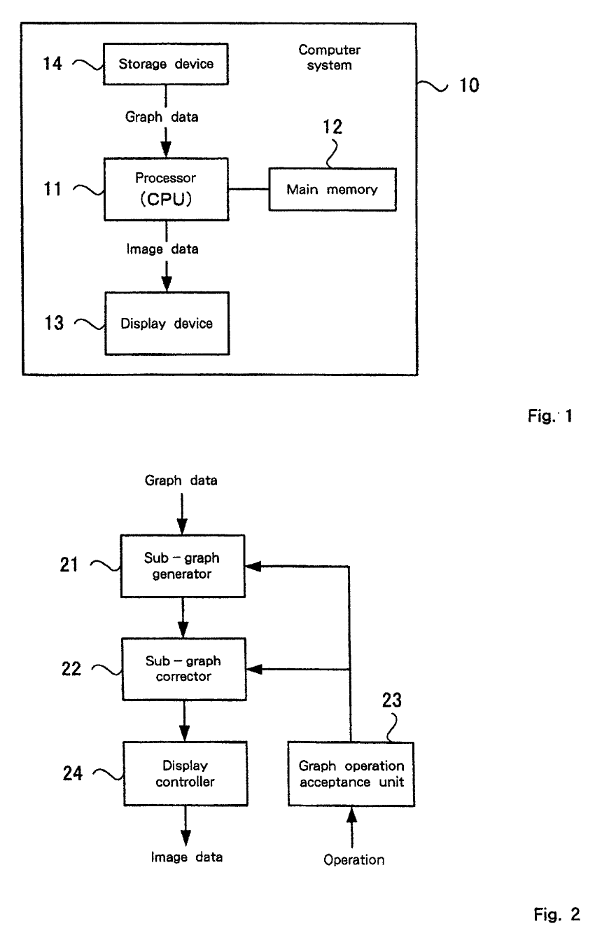

FIG. 1 is a diagram showing the configuration of a computer system according to the embodiment constituting a graphics image creation apparatus for the graphics display of graph data.

In FIG. 1, a computer system 10 comprises a processor (CPU) 11, for performing a graphics display process under the control of a program; a main memory 12, in which the program for controlling the processor 11 is stored; a display device 13, for displaying a graphic image for graph data generated by the processor 11; and a storage device 14, in which is stored graph data that is to be processed.

Only the components required to carry out the present invention are shown in FIG. 1, whereas in actuality, in addition to these components, an input device, such as a keyboard or a mouse, for entering various commands and data, a speech output mechanism and other peripheral devices, and an interface for a network are also provided.

FIG. 2 is a diagram for explaining the configuration in this embodiment of the graphics image creation system for the graphics display of graph data.

In FIG. 2, the graphics creation system of this embodiment includes: a sub-graph generator 21, for generating a sub-graph based on graph data for a predetermined group in hierarchical graph data; a sub-graph corrector 22, for correcting a conventional sub-graph when a predetermined sub-graph is newly generated; a graph operation acceptance unit 23, for receiving the operations for nodes and arcs that constitute the sub-graph generated by the sub-graph generator 21; and a display controller 24, for transmitting, to the display device 13, the image data for the sub-graph that has been generated by the sub-graph generator 21 and appropriately corrected by the sub-graph corrector 22, and for displaying the image data on the display device 13.

The components in FIG. 2 are virtual software blocks implemented by the processor 11 that is controlled by a computer program stored in the main memory 12 in FIG. 1. The computer program for controlling the processor 11 is provided by storing it on a storage medium, such as a CD-ROM or a floppy disk, or by transmitting it via a network. The thus provided computer program is loaded into the main memory 12 and then provides control for the CPU 11, so as to use the computer system 10 in FIG. 1 to execute the functions of the components in FIG. 2.

In this embodiment, to automatically arrange the hierarchical graph data in a display space, the graphics image creation system in FIG. 2 repeats the following processes:

(1) the automatic arrangement of a predetermined sub-graph Ga;

(2) the provision of an area of occupation in the sub-graph Ga for a node Na at a higher level that corresponds to the sub-graph Ga; and

(3) the correction of the arrangement of a sub-graph GO at a higher level whereat the node Na is included.

The functions and operations of the individual components in FIG. 2 will now be described in detail.

In the configuration in FIG. 2, the sub-graph generator 21 receives, from the storage device 14, hierarchical graph data to be processed, and generates a sub-graph (a graphics image for a predetermined group) based on graph data for a predetermined level that constitutes part of the graph data at that level. A conventional method, such as a method using a dynamic model like an intermolecular model or a spring model, can be employed for the generation of a sub-graph. Further, since the sub-graph generated by the sub-graph generator 21 is a graphics image for a specific level, the hierarchical structure of the graph data need not be taken into consideration when the sub-graph is generated. Therefore, while the size (area) of a node is defined as being uniform, a dynamic model can be employed to generate the sub-graph. And thus, since the sub-graph is generated by defining the uniform node size, destabilization of the dynamic model can be avoided. Further, a group for which a sub-graph is to be generated may be designated by the graph operation acceptance unit 23, or the topmost level, i.e., a group that includes all the hierarchical graph data that is to be processed, may be initially designated as the target group.

When, while a predetermined sub-graph is currently being displayed on the display device 13, a sub-graph for a lower level is newly generated by the sub-graph generator 21, or a node is added or deleted, the sub-graph corrector 22 corrects the sub-graph (hereinafter referred to a conventional sub-graph) that is currently being displayed on the display device 13.

When the sub-graph for a lower level is generated for a predetermined node in a conventional sub-graph, the size (area) of the node that indicates the pertinent group (the node that is correlated with the sub-graph) is expanded and deformed so as to include the sub-graph for the lower level. This is done because the sub-graph for the lower level is also visually formed into groups. Specifically, after the sub-graph for the lower level is generated, the area occupied by the sub-graph of the lower level is provided for the node. As the size of the node that includes the sub-graph for the lower level is changed, the positional relationships between this node and other neighboring nodes (the distance between the nodes) is changed. Therefore, the entire graphics image, including the sub-graph for the lower level, is again corrected by using the dynamic model between the nodes for which the positional relationships have been changed.

Similarly, after a new node is added to the conventional sub-graph or a predetermined node is deleted therefrom, the positional relationships with the neighboring nodes are also changed. Therefore, the sub-graph is again corrected by using the dynamic model. Further, when the area occupied by the sub-graph is changed by correcting the sub-graph, the size of the node correlated with the sub-graph is also changed. Thus, since the positional relationships between the node and other neighboring nodes are changed, the dynamic model is again used for these nodes and the entire graphics image is corrected.

For the correction of a graphics image, the dynamic model can be employed locally. Assume that the sub-graph for a higher level is formed of N nodes and a sub-graph for a lower level is generated for one of the nodes, and that the area occupied by a sub-graph for a lower level is provided for that node. At this time, while an intermolecular model is used for nodes and a spring model is used for arcs, the attractive force and the repulsive force exerted between the node for which the size is changed and its neighboring nodes, and the locations of the neighboring nodes are calculated using the equation of motion. When there is a node for which the distance travelled is large, the same process is performed between that node and its neighboring nodes.

Specifically, when the node size is changed by adding the sub-graph of the lower level, or when the node is added or deleted, the positional relationship of the nodes is greatly changed at the periphery of the node for which the size has been changed or the node that has been added or deleted. Therefore, by repeating the process for correcting the node arrangement by using the dynamic model locally for the peripheral nodes and for further employing the dynamic model for the nodes that are specifically affected by the arrangement correction, the graphics image is corrected. Through this process, the re-calculation of the locations of the nodes must be performed locally for the periphery of the area in which the node for which the size has been changed is located or in which the node is added or deleted, and the node arrangement need not be corrected for an area that is less affected by this change. Thus, compared with a case wherein all the nodes are rearranged by using the dynamic model for the entire graphics image, a small number amount of calculations, i.e., a short time, is required for the correction of the graphics image.

Further, upon receiving an instruction from the graph operation acceptance unit 23, the sub-graph corrector 22 performs a partial expansion of the display space wherein the sub-graph is arranged. During this process, while the coordinate values for a node designated in the sub-graph is defined as the center point, other displayed nodes are moved in directions leading away from the center point. This process can be employed when a user enlarges a specific desired portion in the sub-graph to improve the visibility of the pertinent portion. The distance travelled by each node is determined as follows.

(a) When a node belongs to the same group as a designated node, the node is moved away from the center point a distance proportional to the distance to the center point.

(b) When a node belongs to a different group (including a group of higher group) from the designated node, the node is moved away from the center point a distance inversely proportional to the square of the distance to the center point.

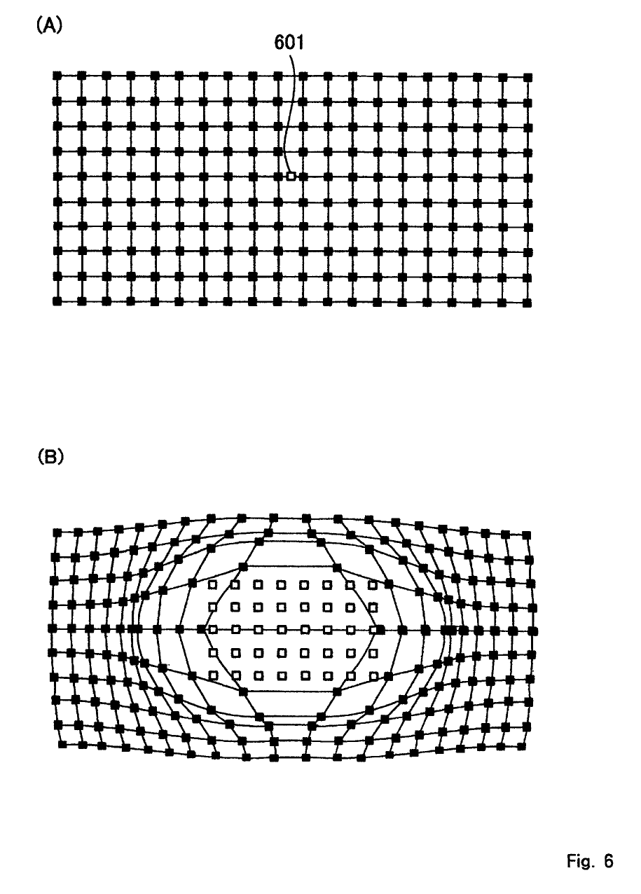

FIGS. 6A and 6B are diagrams for explaining the process for the partial space expansion performed for a grid graphics image. For a graphics image in FIG. 6A, the space is partially expanded at a center point 601 (in this example, not a node but predetermined coordinates in a display space), and the result is shown in FIG. 6B.

As is shown in FIGS. 6A and 6B, the expansion process is only partially performed. The affect on the nodes near the center point 601 is the greatest, and to increase visibility, the distances between them are extended the furthest, while the nodes located at a distance from the center point 601 are not so strongly affected and the distances they travel are consequently smaller.

This partial space expansion process can also be used to obtain an area in which to arrange the sub-graph of a lower level.

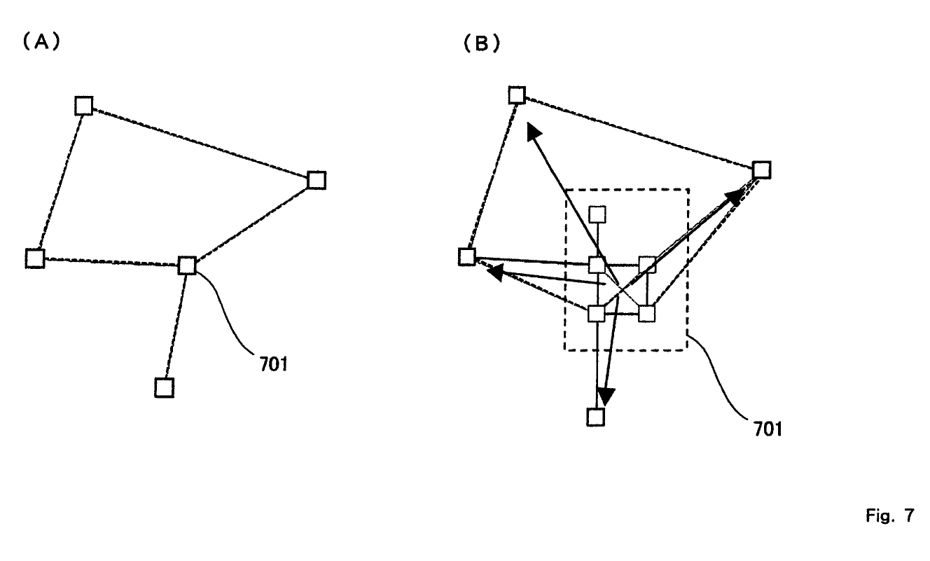

FIGS. 7A and 7B are diagrams showing the process for the partial space expansion performed for a specific node, and for the arranging, in the obtained space, of the sub-graph for a lower level of the node. The partial space expansion process is performed for a node 701 in FIG. 7A, and as is shown in FIG. 7B, the sub-graph for the lower level of the node 701 is generated in the thus obtained space.

When, through this partial space expansion process, an appropriate space can be obtained and a sub-graph can be arranged, the re-arrangement of the nodes by the sub-graph corrector 22 using the dynamic model may not be performed. It should be noted, however, that whether a space for arranging a sub-graph can be appropriately obtained by the partial space expansion process depends on the structure of the hierarchical graph data and which node the user employs to generate a sub-graph for a lower level.

The graph operation acceptance unit 23 receives an operation for the sub-graph generated by the sub-graph generator 21. The operations performed for the sub-graph can be the selection, the deletion or the addition of a node and the re-extension of an arc.

When a sub-graph generated by the sub-graph generator 21 is displayed on the display device 13, the user can perform various operations for the sub-graph using a pointing device, such as a mouse, or a keyboard. Specifically, by clicking the mouse to issue an instruction a user can select a desired node or can delete a selected node, add a new node to the sub-graph, or re-extend an arc linking the nodes in the sub-graph. Upon receiving an instruction issued in this manner, the graph operation acceptance unit 23 in turn issues an instruction either to the sub-graph generator 21 or to the sub-graph corrector 22 for the generation or the correction of the sub-graph.

The display controller 24 displays, on the display device 13, a sub-graph that is generated by the sub-graph generator 21 and is corrected as needed by the sub-graph corrector 22. In this embodiment, the perspective projection method is employed as a standard projection method for the display of a sub-graph.

Generally, parallel projection is employed as the projection method for the graphics display of graph data. However, since in a display produced using parallel projection the same size is used both for objects near a viewpoint and for objects distant from it, it is difficult to obtain a stereoscopic image. Therefore, when it is assumed that parallel projection is to be employed for the graphics display of hierarchical graph data, and a specific portion is displayed in which different levels are depicted, it would be difficult to apprehend the depth of each part that is displayed.

In this embodiment, therefore, perspective projection is employed for the display of a hierarchical graph.

Perspective projection, as well as parallel projection, is popular in the computer graphics field, and is used to display three-dimensional space on a two-dimensional screen. With perspective projection, an object at a distance appears smaller than an object in the near foreground, and an object infinitely farther from the viewpoint is displayed so that it is compressed and reduced in size as a point called the vanishing point is neared. To implement this type of display, space in a truncated pyramid shape that is formed by the field of view at a specific angle from the viewpoint is converted and is distorted to produce pillar-shaped space. That is, in the view produced by this deformation, a side nearer the viewpoint is expanded relative to a side more distant from the viewpoint. As a result, distance is expressed by displaying a distant object smaller than an object to its front.

When a graphics image of hierarchical graph data is to be arranged in the display space, the nodes of the sub-graphs for the individual levels can be arranged on the xy plane, and the depth of the level of the graph can be used as the z coordinate value. In this embodiment the z value is increased as the depth of the level depicted in the graph becomes greater, and while the layout of the nodes in three-dimensional space is obtained, a perspective projection is presented on the display device 13. When a graphics image is displayed on the display device 13, basically, the graphics image is viewed in the direction perpendicular to the xy plane. That is, the line of sight in the positive direction along the z axis is employed (it is also possible for the line of sight in an arbitrary direction to be provided and for a display along the z axis to be presented in the oblique direction).

The visual angle employed is that at which a node at an observed level can be satisfactorily displayed, and a level higher than the observed level is not displayed.

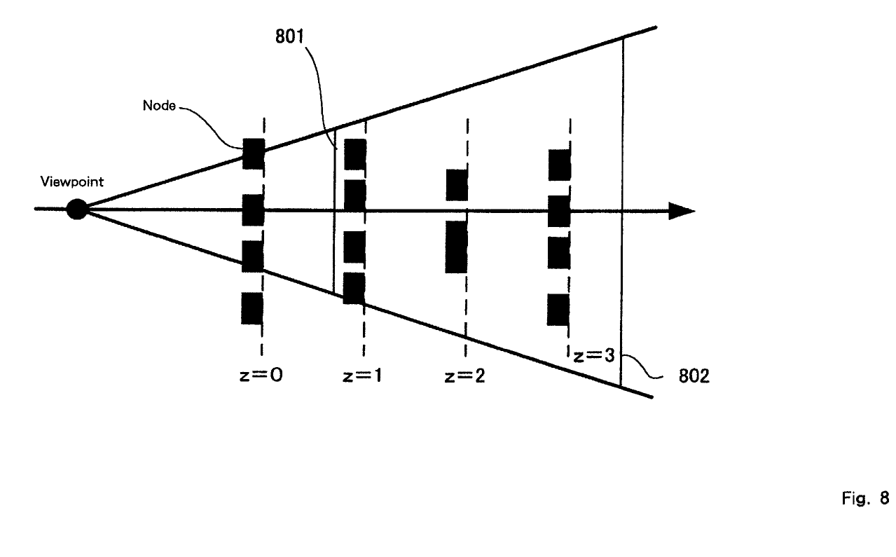

FIG. 8 is a diagram for explaining the perspective projection. In FIG. 8, the graph data has four levels, from z=0 to z=3, and the space from a front projected plane 801 to a rear projected plane 802 is displayed on the display device 13. In this case, the front projected plane 801 is placed at the observed level (z=1), and a projected plane is prepared on which the nodes at the level (z=1) are appropriately included. At this time, when the position of the viewpoint is farther distant (the z value is small), the visual angle is narrowed and the sense of depth is low. The sense of depth when the nodes at a lower level are displayed can be adjusted by controlling the position of the viewpoint.

As is described above, according to the perspective projection, space having a truncated pyramid shape from the front projected plane 801 to the rear projected plane 802 in FIG. 8 is converted into the space having a square pillar shape that is consonant with the screen size of the display device 13. This conversion is performed by multiplying the x and y coordinates in the xy plane by the value obtained using equation 1, wherein the visual angle is defined as q.

$$P = \frac{1}{z tan ( \frac{θ}{2} )} \qquad [ Equation 1 ]$$

As a result, the obtained x and y coordinate values have a value of −1 to 1, i.e., the x and y coordinate values fall within the truncated pyramid defined by the view field. Therefore, by using these values, the xy plane in the truncated pyramid space can be changed so as to match the width of the screen of the display device 13.

The perspective projection process affects not only the coordinate value of a node but also the size of the node. Therefore, both the distance based on the location of the node and the distance based on the size of the node can be expressed. The perspective projection process can also affect the thickness of an arc linking the nodes. Specifically, the width of an arc located near (at a higher level) the viewpoint is increased, and the width of an arc located farther (at a lower level) from the viewpoint is reduced. When an arc is only one pixel wide, a finer arc farther from the viewpoint can not be displayed; however, when the color of a farther arc is blended with the background color, this arc can be expressed as though it was finer. Similarly, when a predetermined filtering process is performed for a graphics image, visual effects can be obtained according to which a node at a distance presented a faded appearance. In this case, the background color that is to be blended with a node and an arc located at distance should be darkened.

Further, when a graphics API, such as OpenGL, that supports perspective projection is employed, an object at a distance is displayed darker by using the depth effect function, so that the distance can more easily be expressed.

For the display of nodes using perspective projection, a rear node must be so displayed that it is hidden by a front node in a portion where they overlap. For this display, the well known Z sorting method can be employed. According to the Z sorting method, objects are drawn in order beginning with the object having the greatest z value, i.e., the rearmost object, and the front most object is drawn over the object to the rear. In this embodiment, since the objects are drawn beginning at the lowest level of the graph data by applying the Z sorting method, a graphics image viewed from the topmost level can be represented.

An explanation will now be given for the processing performed by the thus arranged graphics creation system to generate a graphics image.

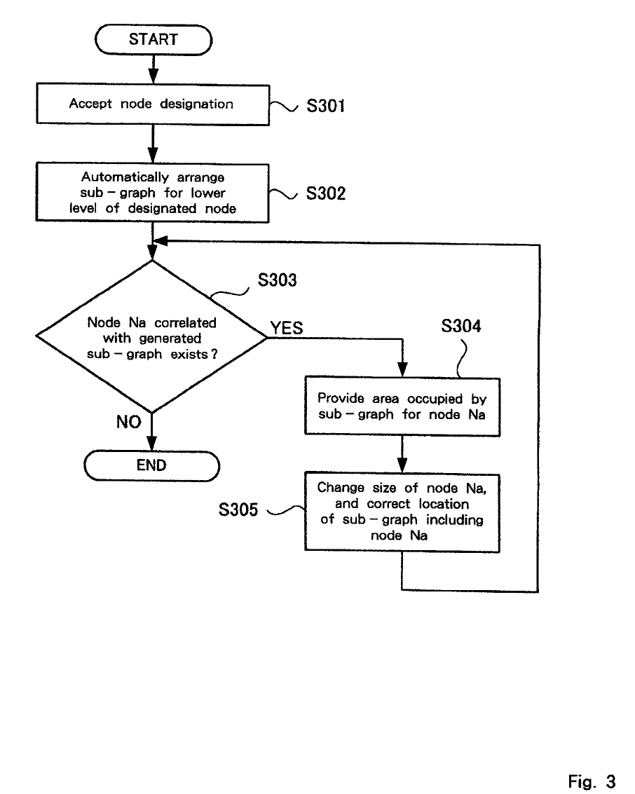

FIG. 3 is a flowchart for explaining the processing performed by the sub-graph generator 21, the sub-graph corrector 22 and the graph operation acceptance unit 23 in FIG. 2 to generate a graphics image to be displayed on the display device 13.

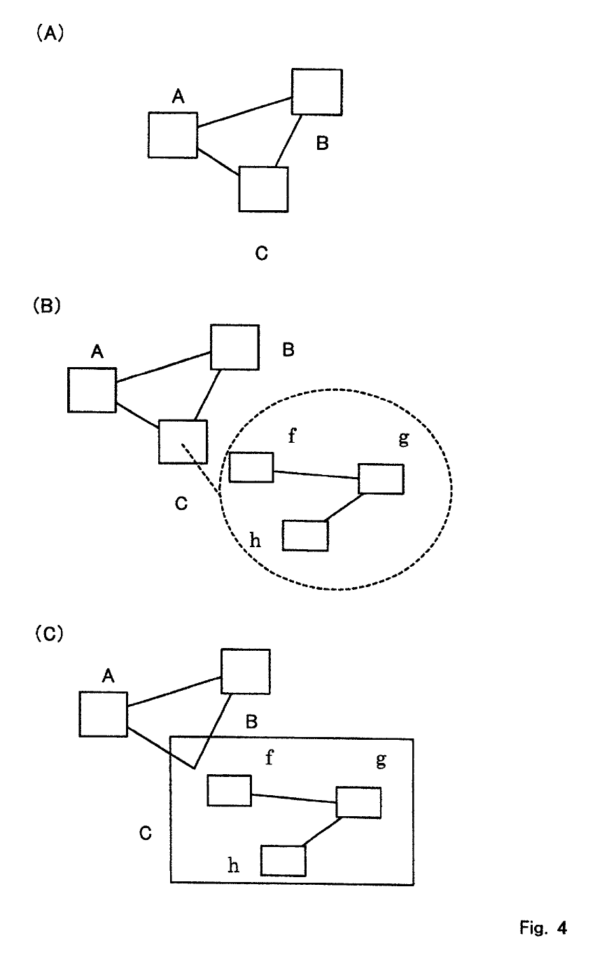

FIGS. 4A to 4C are diagrams showing the state in which a graphics image is generated by the processing in FIG. 3.

First, the sub-graph generator 21 automatically arranges the topmost sub-graph {A, B, C} (see FIG. 4A). At this time, since the structure of the lower sub-graph is unknown and the sizes of nodes A, B and C are constant.

In the state shown in FIG. 4A, the node C is designated to display a lower sub-graph, and this designation is accepted by the graph operation acceptance unit 23 (step 301 in FIG. 3). Then, the graph operation acceptance unit 23 issues an instruction to the sub-graph generator 21 to generate a sub-graph, and the sub-graph generator 21 automatically arranges the sub-graph {f, g, h} of a group indicated by the designated node C (step 302). This state is shown in FIG. 4B.

Following this, the sub-graph corrector 22 determines whether a node Na correlated with the sub-graph generated at step 302 is present (step 303). When the node Na is present, the area occupied by the sub-graph is provided for the node Na (step 304). The area of the node Na is then changed, and the location of the sub-graph, including the node Na, is corrected as the size of the node Na is changed (step 305).

In the example in FIGS. 4A to 4C, since the node C is correlated with the sub-graph {f, g, h} generated at step 302, the area occupied by the sub-graph {f, g, h} is provided for the node C. Then, the area of the node C is changed so as to include the sub-graph {f, g, h}, and the location of the sub-graph {A, B, C} that includes the node C is corrected. The obtained state is shown in FIG. 4C.

When it is ascertained at step 303 that the node Na correlated with the sub-graph is not present, i.e., when the processes at steps 304 and 305 have been performed for the node Na, the processing is terminated.

The graphics image generated through this processing is displayed on the display device 13 by the display controller 24.

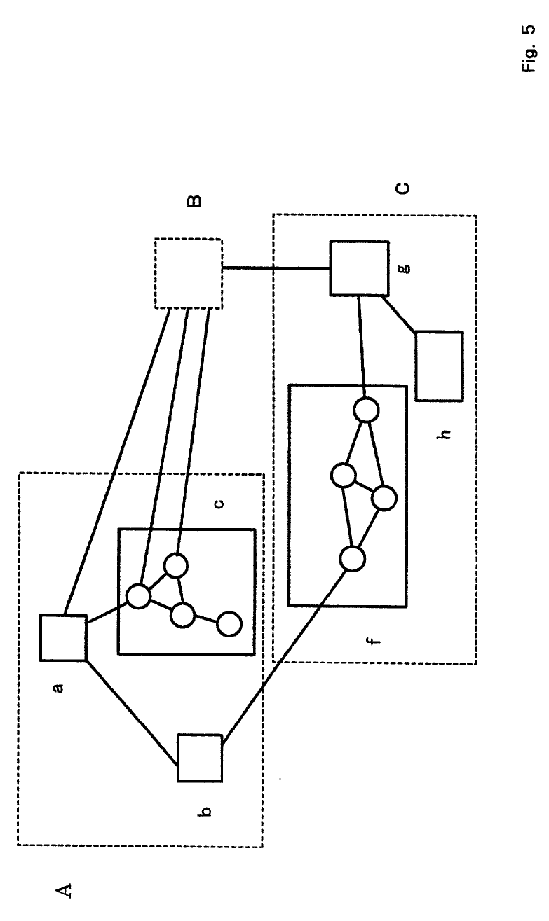

Similarly, when a user selects a desired node and repeats the above processing, a graphics image that includes all the information desired by the user can be generated. FIG. 5 is a diagram showing an example graphics image that finally is generated through this processing.

In FIG. 5, from the state in FIG. 4C, the sub-graph for a level lower than the node f is further generated, and the sub-graph {a, b, c} for a level lower than the node A and the sub-graph for a level lower than the node c are displayed.

As is described above, according to this embodiment, the sub-graphs are automatically arranged beginning with the topmost level in order to present a graphics display of hierarchical graph data. When the sub-graphs for a lower level are generated, the higher level can be notified of the area occupied by these sub-graphs. Therefore, no interference occurs between the nodes at a lower level, or between the lower sub-graph and the higher sub-graph.

Further, at the time whereat the sub-graphs are automatically arranged, the sizes of the nodes are defined as constant, without taking the lower sub-graphs into account. Thus, the phenomenon wherein the dynamic model used for the node arrangement is not stabilized can be avoided.

An explanation will now be given for an example wherein the graphics display is presented by applying this embodiment for various hierarchical graph data.

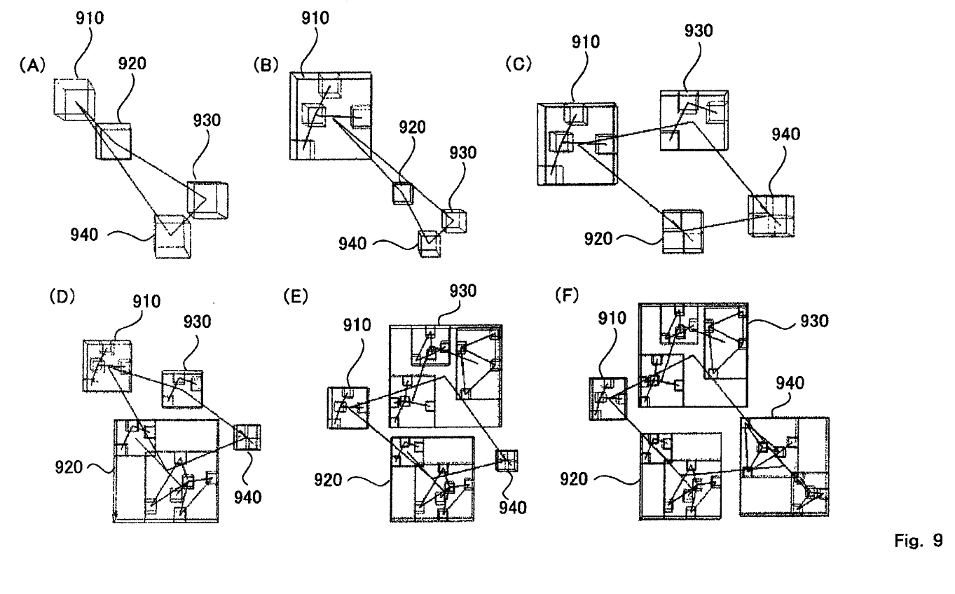

FIGS. 9A to 9F are diagrams showing the process for generating a graphics image for hierarchical graph data having 35 nodes and a three-level structure. In FIGS. 9A to 9F, the process for automatically arranging all the sub-graphs, beginning with the topmost sub-graph, is shown in six steps.

FIG. 9A is a diagram showing the state wherein the sub-graph for the topmost level is arranged. FIG. 9B is a diagram showing the state wherein, from the state in FIG. 9A, a lower sub-graph for a node 910 is arranged. FIG. 9C is a diagram showing the state wherein, from the state in FIG. 9B, lower sub-graphs for nodes 920, 930 and 940 are arranged. FIG. 9D is a diagram showing the state wherein a lower sub-graph (lowermost level) is arranged for each node that constitutes a lower sub-graph for the node 920. FIG. 9E is a diagram showing the state wherein a lower sub-graph (lowermost level) is arranged for each node that constitutes a lower sub-graph for the node 930. FIG. 9F is a diagram showing the state wherein a lower sub-graph (lowermost level) is arranged for each node that constitutes a lower sub-graph for the node 940.

While referring to FIGS. 9A to 9F, it is apparent that each time an additional lower sub-graph is generated, the size and the location of the node in the higher sub-graph are changed.

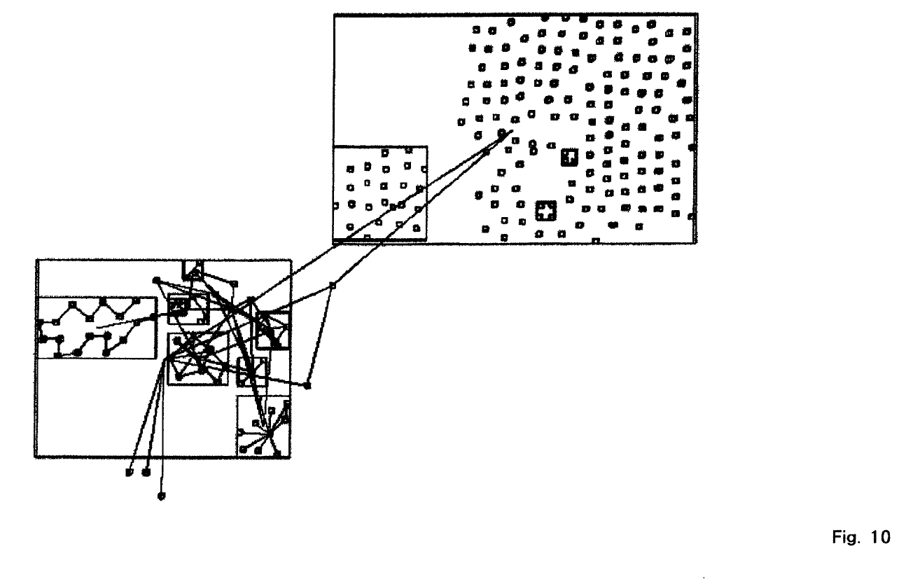

FIG. 10 is a diagram showing an example graphics image of hierarchical graph data that describes information for the linking of pages at a predetermined web site.

As is shown in FIG. 10, with the graphics display in this embodiment, not only the hierarchical structure of a web page that is usually represented using a tree, but also a node linking relationship corresponding to each web page can be visually presented.

In FIG. 10, when the nodes are colored in accordance with the attributes (e.g., a language, the volume of the contents, the number of accesses, the updating frequency and the score attained by a search engine) of a web page, the graphics image can be used for site management.

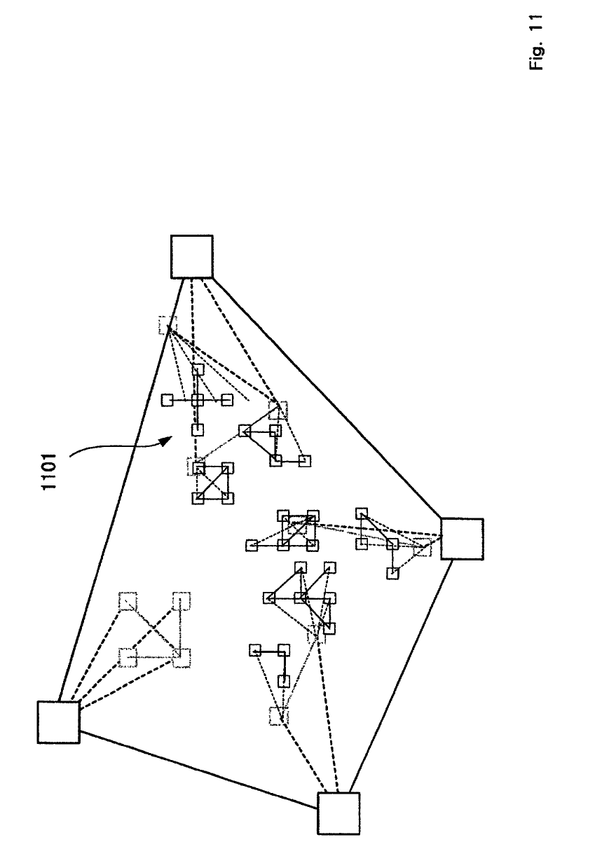

FIGS. 11 to 13 are diagrams showing an example wherein hierarchical graph data is displayed using perspective projection.

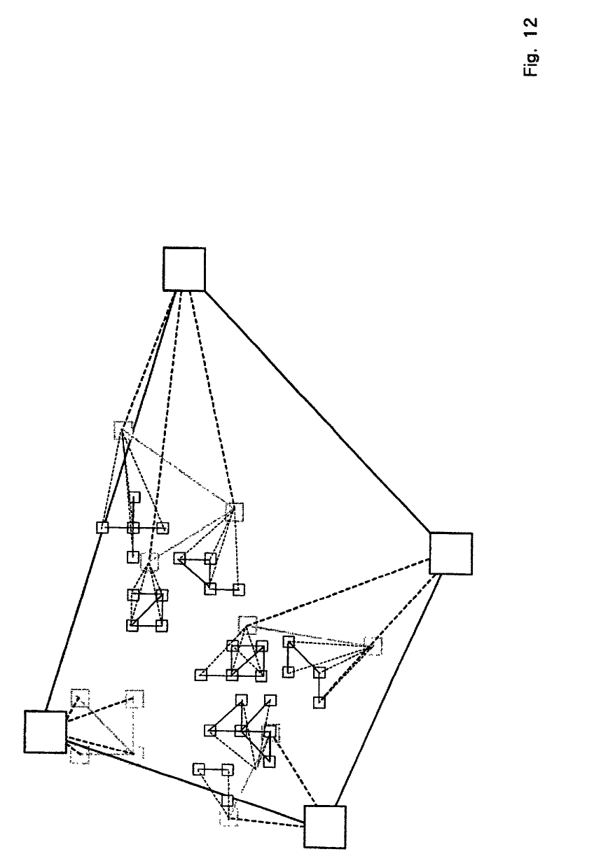

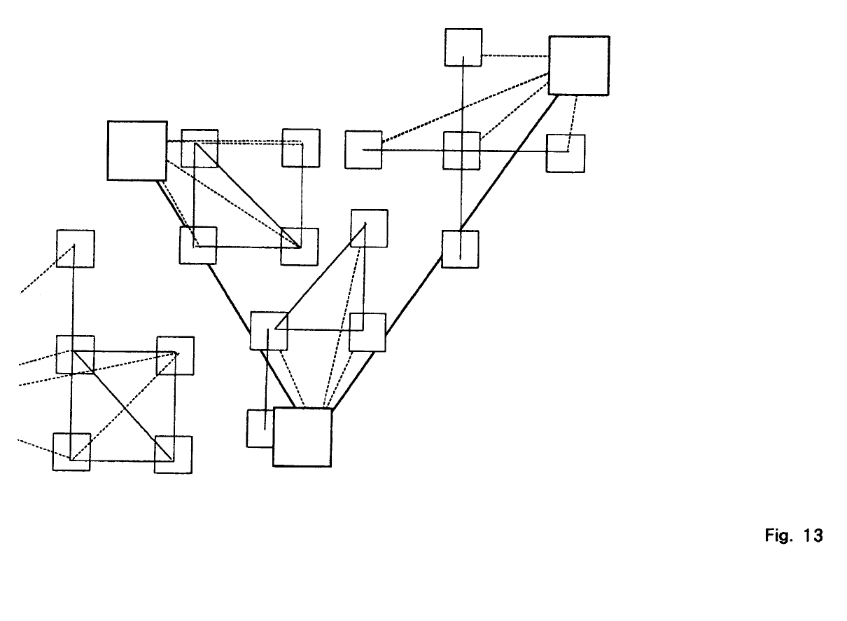

In the image in FIG. 11, the front projected plane 801, which was explained while referring to FIG. 8, is located at a high level. In the image in FIG. 12, the front projected plane 801 is also located at a high level and the location of the viewpoint is changed. In the image in FIG. 13, the front projected plane 801 is located at a low level (second level) and a group 1101 in FIG. 11 is observed.

While referring to FIG. 11, the display state of the sub-graph for a lower level is changed by changing the viewpoint and the observation location, and this change can express depth, so that the hierarchical structure can be displayed in a manner that renders it easily understood.

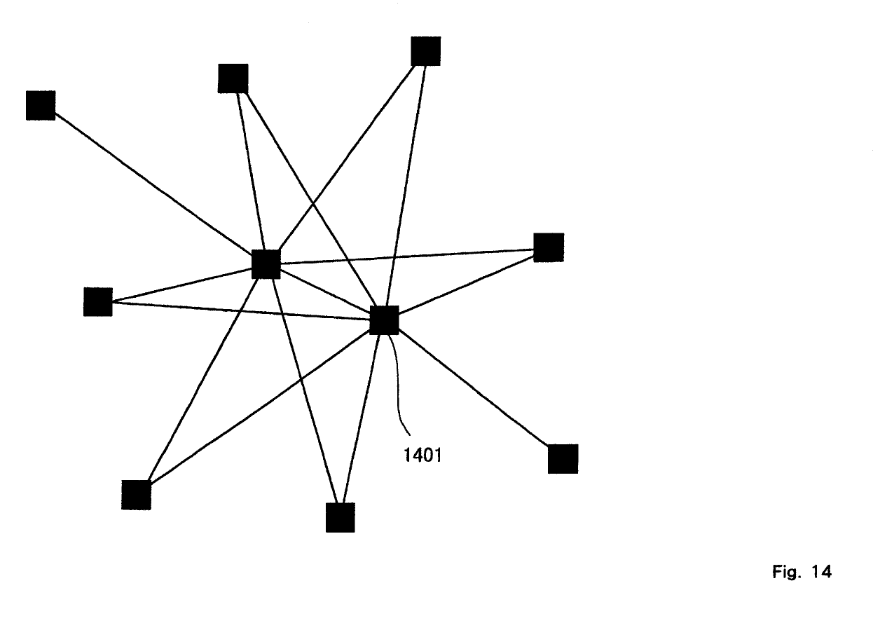

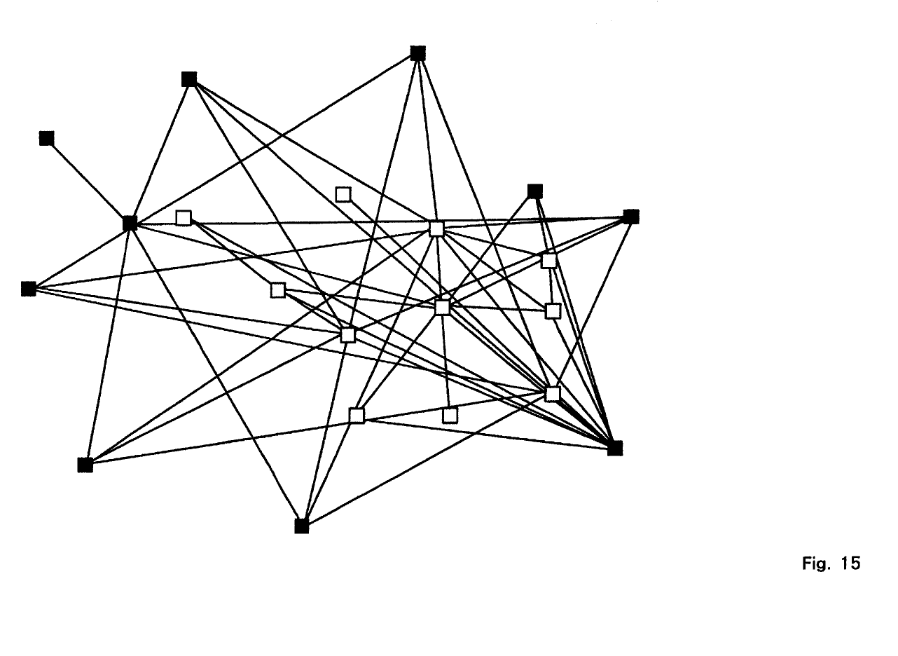

FIGS. 14 and 15 are diagrams showing an example wherein hierarchical graph data for a web site are displayed using the partial space expansion process.

In this example, the space is expanded around a node 1401 in FIG. 14 that serves as the center point. As a result, since the other nodes are moved in every direction away from the node 1401 that serves as is the center point, and a gap is obtained around the node 1401, as is shown in FIG. 15, the lower sub-graph for the node 1401 can be displayed. In FIG. 15, nodes that constitute the lower sub-graph for the node 1401 are indicated by white squares.

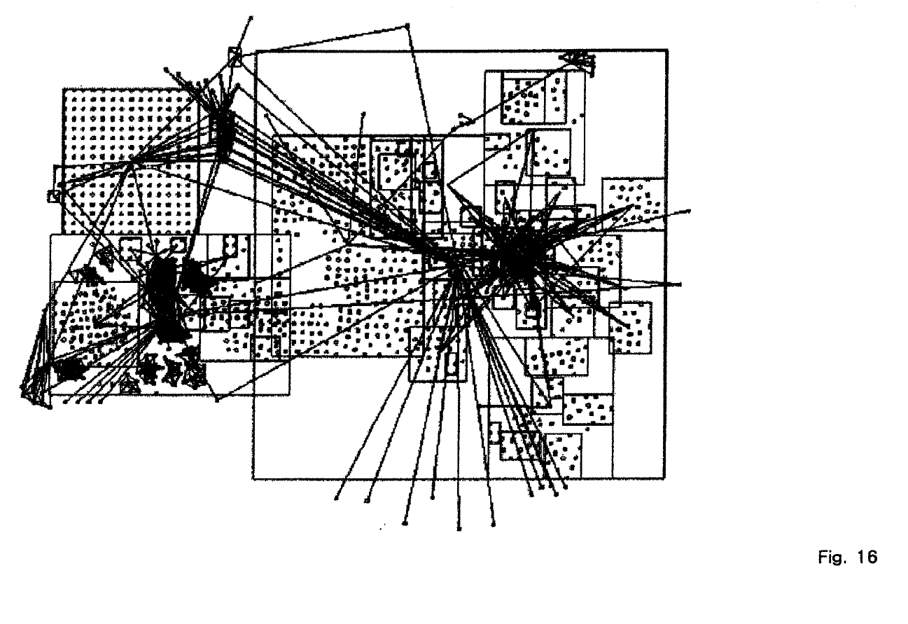

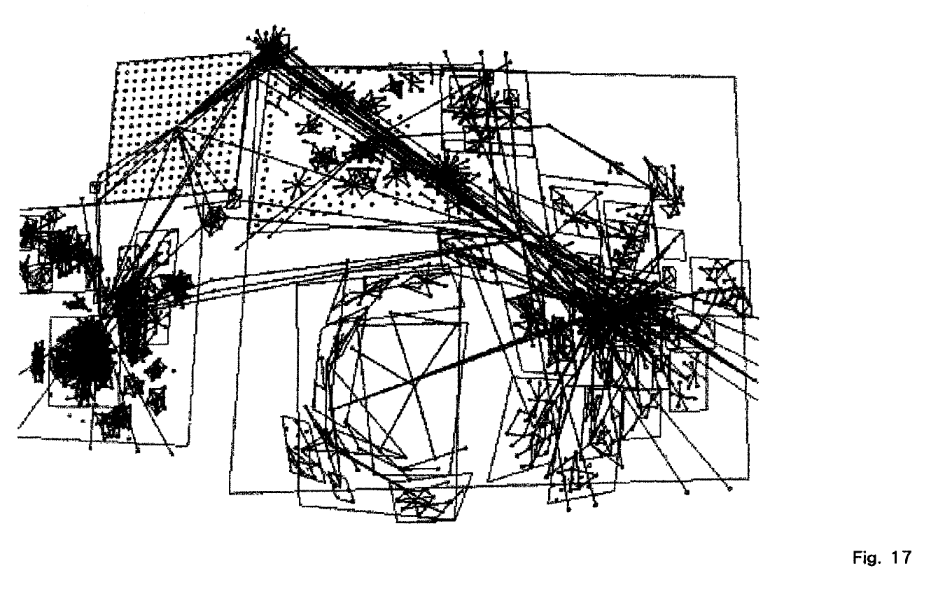

FIGS. 16 and 17 are diagrams showing a graphics image that is generated in this embodiment for hierarchical graph data that indicates the connection (the linking) of all the web pages that are disclosed for www.trl.ibm.co.jp.

In FIG. 16, all of the sub-graphs that constitute the hierarchical graph data are automatically arranged. In FIG. 17, the state in FIG. 16 is deformed by performing the partial space expansion process for several nodes.

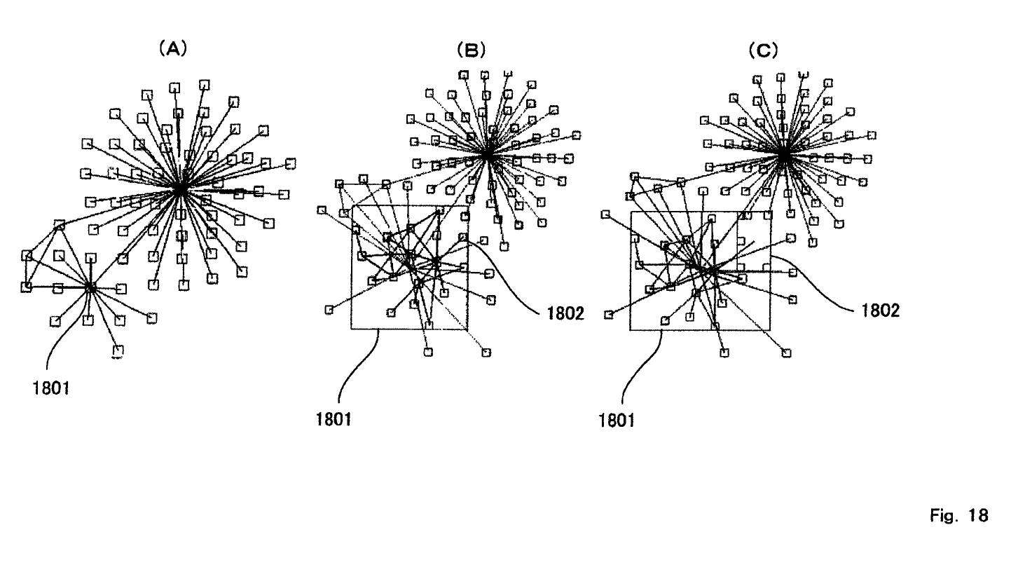

FIGS. 18 to 20 are diagrams showing a graphics image that is generated in this embodiment for hierarchical graph data that indicates the connection (the linking) of the web pages that are disclosed for w3.trl.ibm.com.

FIG. 18A is a diagram showing the state wherein the sub-graph for the topmost level is arranged. FIG. 18B is a diagram showing the state wherein a sub-graph lower than a node 1801 in FIG. 18A is arranged. And FIG. 18C is a diagram showing the state wherein a lower sub-graph for a node 1802 in FIG. 18B is arranged.

While referring to FIGS. 18A to 18C, it is apparent that each time an additional lower sub-graph is generated, the size and location of a node in the higher sub-graph are changed.

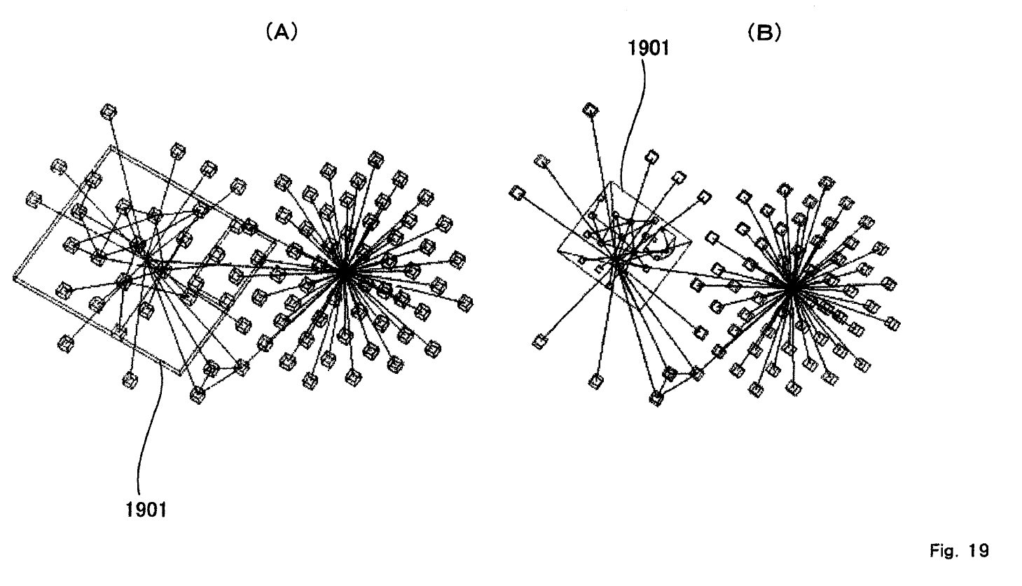

FIG. 19A is a diagram showing the state wherein the viewpoint is shifted from the state shown in FIG. 18C. Due to this shifting, the individual nodes are displayed stereoscopically. It should be noted, however, that up to this step perspective projection has not been employed for the expression of the graphics image. FIG. 19B is a diagram showing the state wherein perspective projection has been employed for the state in FIG. 18C. At this time, the Z axis is set so that the lower sub-graph is observed at distance. Therefore, the sub-graph of a node 1901 is displayed small. For providing an understanding of the connections of nodes, the state in FIG. 19A is better than that in FIG. 19B because the smallest node has the same size. Further, for providing an understanding of the depth of the level, the state in FIG. 19B is better because the difference in levels is represented by using the difference in the distances.

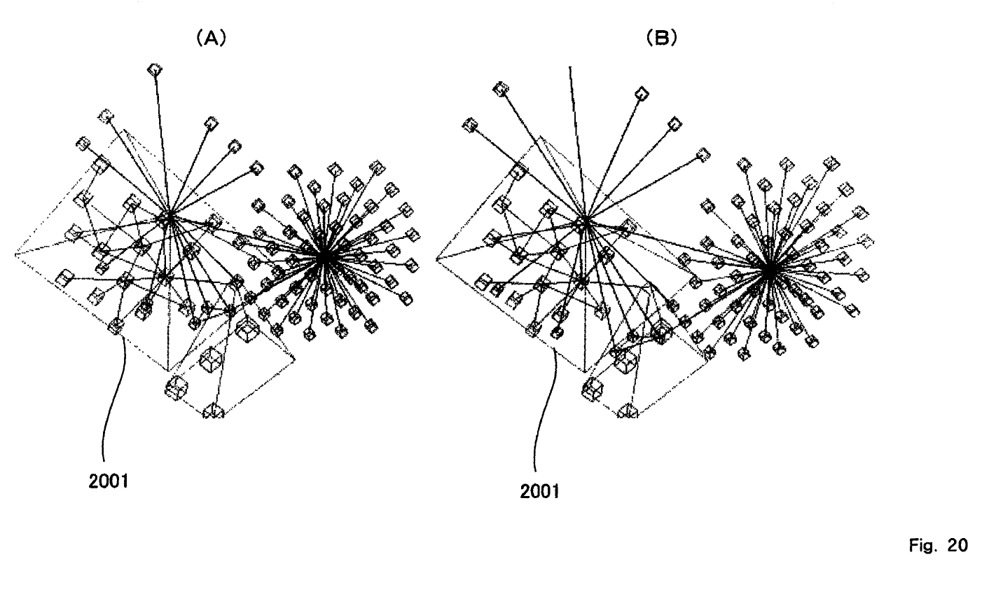

FIG. 20A is a diagram showing the state wherein the perspective projection is employed while the z coordinate value is determined to permit the lower sub-graph to be observed from the front. That is, in this graphics image, the hierarchical graph data is viewed from the lower level side. FIG. 20B is a diagram showing the state wherein the space for a higher sub-graph is partially expanded within the periphery of a node 2001 in FIG. 20A. Therefore, since a higher node allocated within the periphery of the node 2001 is moved away from the node 2001, interference between the lower sub-graph for the node 2001 and the higher sub-graph, including the node 2001, can be reduced.

For facilitating the understanding of the hierarchical graph data, the display forms in FIGS. 20A and 20B may be better, depending on the type of hierarchical graph data and the type of information that is to be obtained from the graphics image.

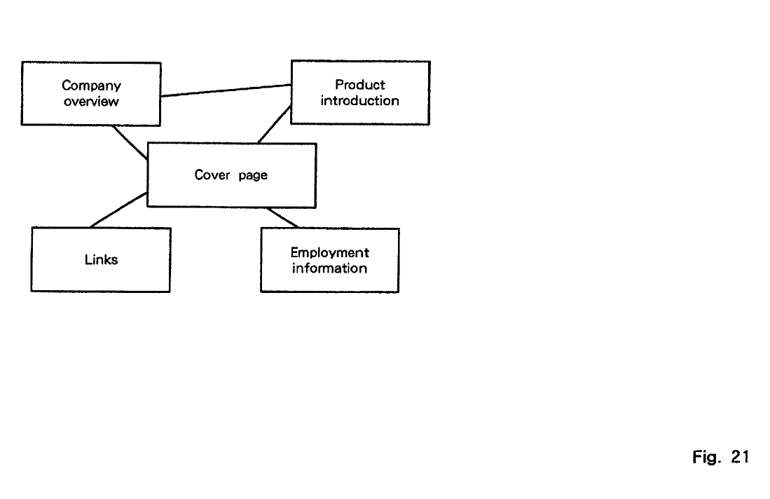

FIGS. 21 to 23 are diagrams showing a graphics image that is generated on the assumption that it is the web site of a predetermined company and that it is based on hierarchical graph data that describe the web page linking structure of this web site.

In FIG. 21, a sub-graph for a topmost level includes five nodes: “cover page”, “company overview”, “products introduction”, “employment information” and “links”.

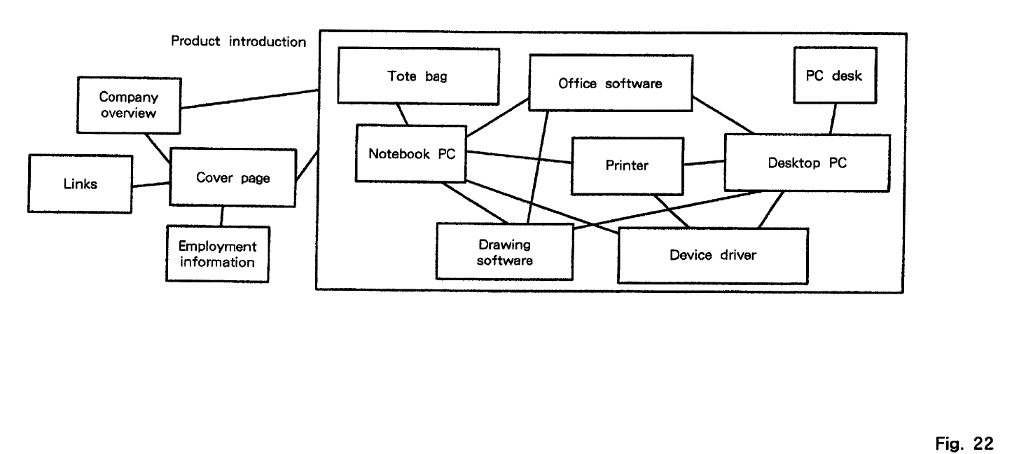

In FIG. 22, a lower sub-graph for the node “products introduction” in the sub-graph in FIG. 21 is displayed.

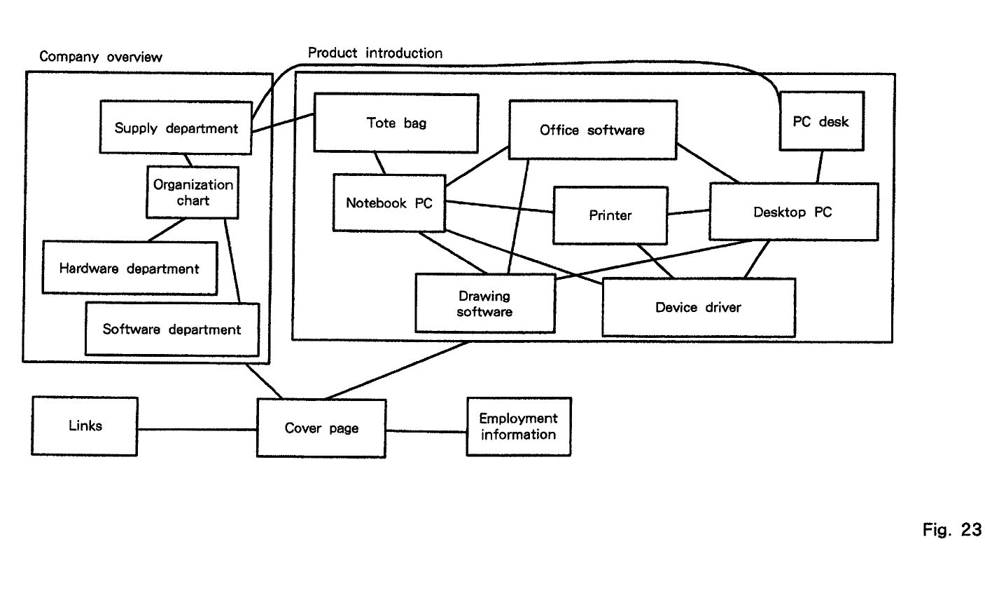

In FIG. 23, a lower sub-graph for the node “company overview” in the state in FIG. 22 is displayed. In FIG. 23, the arc extended between the node “company overview” and the node “products introduction” is replaced with the arc extended between the node “supply department”, which is included in the lower sub-graph for the node “company overview”, and the node “tote bag” and the node “PC desk”, which are included in the lower sub-graph for the node “product introduction”. That is, it is understood that the arc also represents the linking relationship of the lower levels. A user need only select an arbitrary level linking relationship that is represented by arcs.

While referring to FIGS. 21 to 23, it is apparent that each time an additional lower sub-graph is generated, the size and location of a node in a higher sub-graph are changed.

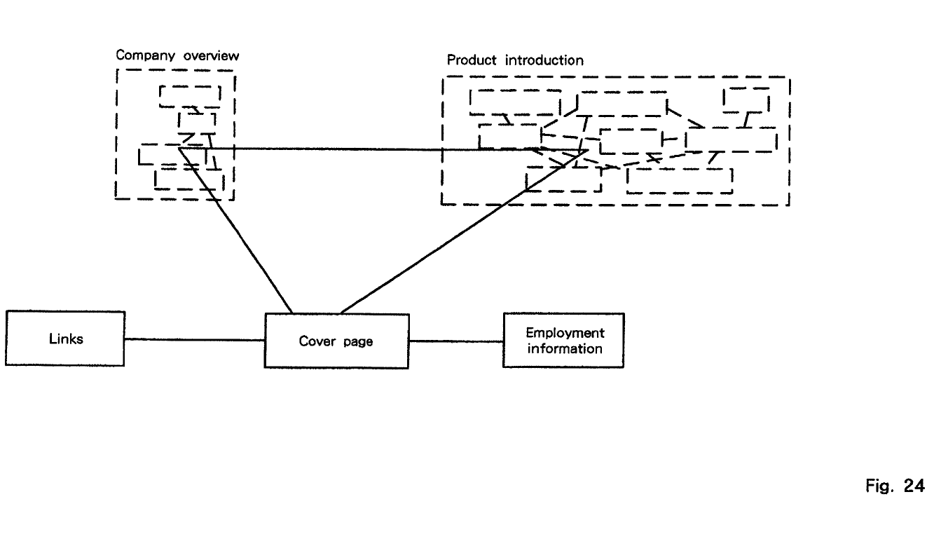

FIG. 24 is a diagram showing the state wherein a graphics image in FIG. 23 is displayed using perspective projection, while the higher level is located in the front and the lower level is located to the rear.

In FIG. 24, the portions indicated by broken lines are sub-graphs displayed to the rear. Using perspective projection, not only can the depth of the level be easily understood, but also the higher level can be easily observed, even when the lower sub-graph is displayed.

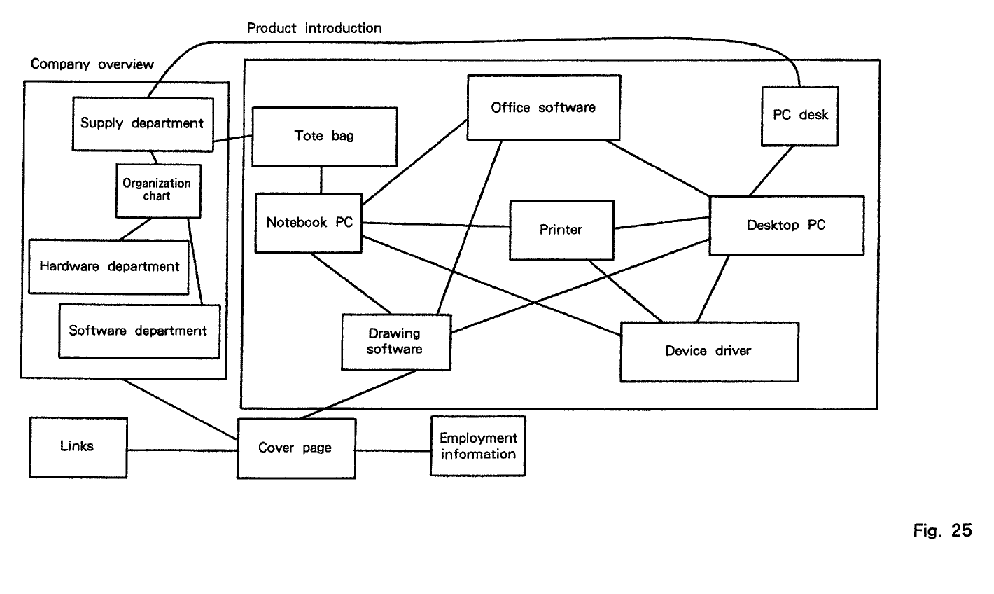

FIG. 25 is a diagram showing the state wherein, for a graphics image in FIG. 23, the partial space expansion process is performed by employing, as the center point, a node “printer” at the lower level of the node “product introduction”.

Therefore, while the entire graphics image as shown in FIG. 23 is displayed, a satisfactory amount of display space can be provided for the node “product introduction”, and the complicated connection relationships in the lower sub-graph can be easily understood.

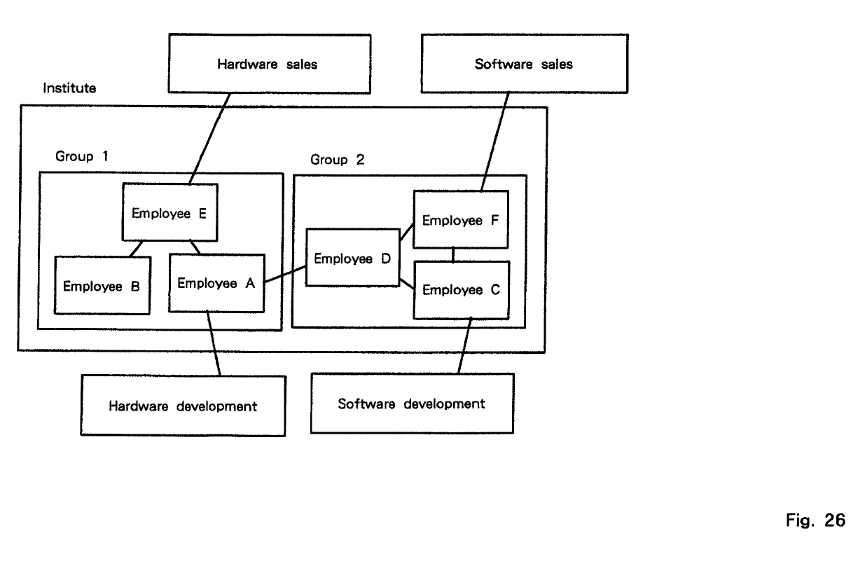

FIG. 26 is a diagram showing a graphics image that is generated based on hierarchical graph data that it is assumed represent the personnel management structure of a predetermined company.

In the example in FIG. 26, the work relationship among employees in an institute and the relationship between the institute and external organizations are simultaneously shown. A lower sub-graph is generated only for a node that corresponds to the institute, while only a higher sub-graph is displayed for another node.

In this embodiment, in principle, perspective projection is employed as the graphics image display method; however, in some cases, parallel projection is more convenient than perspective projection. That is, while perspective projection is appropriate for providing an understanding of the depth of a level because the hierarchical structure of a sub-graph is expressed stereoscopically, a lower sub-graph that is displayed is small, and the nodes and arcs are complicated. Therefore, when only a sub-graph for a specific level is to be observed to provide an understanding of the complicated connections of nodes, parallel projection may be more effective.

Besides the above web page link structure, the personnel organization of the company can be employed as example data that can be effectively displayed using this embodiment. That is, while the ranks in the organization are reflected, hierarchical graph data is prepared that includes, as inter-node information, the work performed among departments or among employees, and the handling of money. Then, when sub-graphs down to lower levels are generated for a desired organization and only a sub-graph for a higher level is displayed for another organization, the relationship between the interior of the desired organization and the peripheral organization can be displayed.

In addition, the technique in this embodiment for generating a graphics image for hierarchical graph data can be appropriately employed for the following fields and for visualizing the organization structure.

1. A graph is formed for the network of a computer system and is used to manage the traffic volume and to detect failures.

2. A graph is formed for a financial, transportation and communication network, and is used either to understand the volume of the transactions or to predict the future.

3. A graph is formed for the network of a hierarchical organization, such as a self-governing community or a company personnel organization, in order to optimize personal resources.

4. While data in a text data group or an image data group are employed as nodes, a graph is formed by linking these nodes in accordance with their correlation, so that the entire data structure as well as data trends can be understood.

5. While sequence patterns in gene data are employed as nodes, a graph is formed by linking these nodes in accordance with their correlation, and the characteristic and the rule are found.

6. While in a software programming environment functions and classes are employed as nodes, a sub-graph for each project is formed by linking nodes in accordance with a retrieval correlation, so that the software development process can be understood.

Having thus described our invention, what we claim as new, and desire to secure by Letters Patent is:

1. A graphics image creation apparatus comprising:
a sub-graph generator, for employing hierarchical graph data to generate a sub-graph comprising a graphics image that includes nodes and arcs for connecting said nodes, at a predetermined level; and
a sub-graph corrector, for, when said sub-graph generator has generated a sub-graph for a level lower than a predetermined node in said sub-graph that has already been generated, correcting the location of a node in said sub-graph that has already been generated.

2. The graphics image creation apparatus according to claim 1, wherein said sub-graph corrector changes the size of a node that corresponds to said sub-graph that is newly generated for said lower level, so that said sub-graph for said lower level is included in said node for which the size had been changed, and removes all other nodes from said sub-graph that has already been generated.

3. The graphics image creation apparatus according to claim 2, wherein said sub-graph corrector rearranges nodes by locally employing a dynamic model between said node for which the size has been changed and another nearby node.

4. A graphics image creation apparatus comprising:
a processor, for generating a graphics image that includes nodes and arcs for connecting said nodes, based on graph data; and
a display unit, for displaying said graphics image generated by said processor,
wherein, when said processor generates a sub-graph that constitutes a graphics image for a predetermined level in hierarchical graph data, said processor changes the size of a node that corresponds to said sub-graph so as to include said sub-graph in said node, and moves a neighboring node of said node for which the size has been changed.

5. The graphics image creation apparatus according to claim 4, wherein said processor employs, as the size of a node that corresponds to said sub-graph, the area occupied by said sub-graph in the display space of said display unit.

6. The graphics image creation apparatus according to claim 4, wherein, when a sub-graph for a predetermined level is corrected, said processor changes the size of a node in accordance with said sub-graph that has been corrected, and moves a node near said node for which the size has been changed in order to avoid any interference with said sub-graph.

7. The graphics image creation apparatus according to claim 4, wherein, when said graphics image generated by said processor has a hierarchical structure, said display unit displays an arbitrary level using a perspective projection appropriate for a display screen.

8. A graphics image creation apparatus comprising:
a processor, for generating a graphics image that includes nodes and arcs for connecting said nodes, based on graph data; and
a selected node receiver, for accepting a node that is selected to constitute a first graphics image that is generated by said processor,
wherein, when graph data for a lower level exists for a node that is accepted by said selected node receiver, said processor generates a second graphics image based on said graph data for said lower level, and corrects said first graphics image.

9. A graphics image creation apparatus comprising:
a processor, for generating a graphics image that includes nodes and arcs for connecting said nodes, based on graph data; and
a selected node receiver, for accepting a node that is selected to constitute a graphics image that is generated by said processor,
wherein, in a display space wherein a graphics image is displayed, said processor moves other displayed nodes away in directions opposite to those leading to a center point that corresponds to the coordinate values for a selected node that is accepted by said selected node receiver.

10. The graphics image creation apparatus according to claim 9, wherein said processor determines a travel distance for said node based on the distance from said selected node, which is accepted by said selected node receiver, and the hierarchical structure of said generated graphics image.

11. A graphics image creation method, for reading graph data from a storage device and transmitting said graph data to a data processor to generate a graphics image, comprising the steps of:
generating a graphics image based on graph data to be processed; and
when said newly generated graphics image is a part of a graphics image that has already been generated and is correlated with a predetermined node in said graphics image that has already been generated, rearranging nodes of said graphics image that has already been generated.

12. The graphics image creation method according to claim 11, wherein said step of rearranging nodes includes the steps of:
changing the size of a node that corresponds to said graphics image that is newly generated, so as to include in said node said graphics image that is newly generated; and
moving another node in said graphics image that has already been generated so as to distance that node from said node for which the size has been changed.

13. A graphics image creation method, for reading hierarchical graph data from a storage device and transmitting said hierarchical graph data to a data processor to generate a graphics image, comprising the steps of:
generating a sub-graph that is a graphics image for a predetermined level of said hierarchical graph data;
generating a sub-graph for a level lower than a predetermined node in said sub-graph for said predetermined level;
changing the size of a node for which said sub-graph for said lower level is generated, so that said node includes said sub-graph for said lower level; and
moving another node near said node for which the size has been changed.

14. A graphics image creation method, for reading hierarchical graph data from a storage device and transmitting said hierarchical graph data to a data processor to generate a graphics image, comprising the steps of:
accepting an arbitrarily selected node constituting a graphics image displayed on a display device;
generating a graphics image for a level lower than said selected node;
changing the size of said selected node, so that said graphics image for said lower level is included; and
moving another node near said node for which the size has been changed.

15. A graphics image creation method, for reading hierarchical graph data from a storage device and transmitting said hierarchical graph data to a data processor to generate a graphics image, comprising the steps of:
accepting an arbitrarily selected node constituting a graphics image displayed on a display device; and
moving other displayed nodes in directions leading away from a center point that is the coordinate values for said selected node.

16. A program, for controlling a computer to generate a graphics image that includes nodes and arcs for connecting said nodes, which permits said computer to perform:
a process for generating a graphics image based on graph data read from a storage device; and
a process for, when said newly generated graphics image is a part of a graphics image that has already been generated and is correlated with a predetermined node in said graphics image that has already been generated, rearranging nodes of said graphics image that has already been generated.

17. A program, for controlling a computer to generate a graphics image that includes nodes and arcs for connecting said nodes, which permits said computer to perform:
a process for generating a sub-graph that is a graphics image for a predetermined level of hierarchical graph data read from a storage device;
a process for generating a sub-graph for a level lower than a predetermined node in said sub-graph for said predetermined level;
a process for changing the size of a node for which said sub-graph for said lower level is generated, so that said node includes said sub-graph for said lower level; and
a process for moving another node near said node for which the size has been changed.

18. A program, for controlling a computer to generate a graphics image that includes nodes and arcs for connecting said nodes, which permits said computer to perform:
a process for accepting an arbitrarily selected node constituting a graphics image displayed on a display device;
a process for generating a graphics image for a level lower than said selected node;
a process for changing the size of said selected node, so that said graphics image for said lower level is included; and
a process for moving another node near said node for which the size has been changed.

19. A program, for controlling a computer to generate a graphics image that includes nodes and arcs for connecting said nodes, which permits said computer to perform:
a process for accepting an arbitrarily selected node constituting a graphics image displayed on a display device; and
a process for moving other displayed nodes in directions leading away from a center point that is the coordinate values for said selected node.
